(19) United States
(12) Patent Application Publication
(10) Pub. No.: US 2008/0049134 A1
(43) Pub. Date: Feb. 28, 2008

(54) Camera system and method for controlling display during focus operation

(75) Inventor: Kyozo Saito, Fukushima-ken (JP)

Correspondence Address: BEYER WEAVER LLP, P.O. BOX 70250, OAKLAND, CA, 94612-0250, US

(73) Assignee: ALPS ELECTRIC CO., LTD.

(21) Appl. No.: 11/825,255

(22) Filed: Jul. 3, 2007

(30) Foreign Application Priority Data
Aug. 23, 2006 (JP) 2006-226516

(51) Int. Cl. H04N 5/222

(52) U.S. Cl. 348/333.02; 348/E05.001

(57) ABSTRACT

A camera system includes a frame memory having a capacity for storing at least two frames of image data, and stores images output from an image sensor into this frame memory on a frame-by-frame basis. The stored image data is read out and displayed on a monitor. When a shutter button is pressed halfway, a focus operation is started. An image at the point of half-pressing of the shutter button is displayed on the monitor as a still image until the focus operation is completed. Upon completion of the focus operation, the image is switched to a normal image or a macro image in a focused state. Accordingly, this prevents a blurry image from being displayed during a focus operation, thereby reducing a sense of discomfort imparted to a user that can be caused as a result of displaying a blurry image.

### CLAIM OF PRIORITY

This application claims benefit of the Japanese Patent Application No. 2006-226516 filed on Aug. 23, 2006, which is hereby incorporated by reference.

### BACKGROUND OF THE INVENTION

1. Field of the Invention

The present invention relates to camera systems equipped with image sensors, such as CCD (charge coupled devices) and CMOS (complementary metal-oxide semiconductors), and having both normal and macro photography modes, and to methods for controlling display during a focus operation.

2. Description of the Related Art

Generally, camera modules installed in portable telephones have a macro photography mode (or a close-up photography mode) in addition to a normal photography mode. Specifically, a macro photography mode is for photographing a subject, such as a bar code, by bringing the lens close to the subject. An example of such a camera module is disclosed in Japanese Unexamined Patent Application Publication No. 2004-280039. Typical lens shift methods for switching between normal and macro photography modes are a manual method in which the switching is performed manually by the user and an electric method in which the switching is performed automatically by means of electricity. With the manual method, there are cases where the user forgets to reset the mode to the normal photography mode and continues with the shooting under the macro photography mode setting, or vice versa. In contrast, such a problem of forgetting to reset the mode can be avoided with the electric method.

FIG. 4 illustrates a structure of a camera module 100 that employs the electric method. The camera module 100 mainly includes a lens barrel 101, a lens 102, a magnetic segment 103, a housing 104, a prestressed spring 105, an electromagnetic coil 106, an infrared-ray insulating filter 107, and an image sensor 108 such as a CCD or a CMOS.

The magnetic segment 103 has a cylindrical shape and is attached to an outer periphery of the lens barrel 101 holding the lens 102 therein. The magnetic segment 103 and the lens barrel 101 are supported together by a cylindrical portion 109 of the housing 104 in a movable fashion in an optical-axis direction of the lens 102. Normally, the lens barrel 101 is held at a normal photography position P1 within the housing 104 and is maintained in a biased state by the prestressed spring 105. When electricity is applied to the electromagnetic coil 106, which is wound around an outer wall of the cylindrical portion 109, the magnetic segment 103 is drawn towards the electromagnetic coil 106 so as to be shifted away from the image sensor 108. As a result, the lens barrel 101 becomes held at a macro photography position P2. In this manner, the lens 102 is set at the normal photography position P1 for the normal photography mode and at the macro photography position P2 for the macro photography mode. FIGS. 5A and 5B illustrate these states. Specifically, FIG. 5A illustrates a state where the lens 102 is set at the normal photography position P1. In this state, a switch 110 is turned off, meaning that power is not supplied to the electromagnetic coil 106. FIG. 5B illustrates a state where the lens 102 is set at the macro photography position P2. In this state, the switch 110 is turned on, meaning that power is being supplied to the electromagnetic coil 106.

In this camera module having the configuration described above, the switching between the normal photography position P1 and the macro photography position P2 is implemented on the basis of the distance to a subject. For example, the switching of the lens position can be implemented in accordance with the distance to a subject measured with a distance sensor or in accordance with a focus condition determined on the basis of a contrast level of an image.

However, with a costly component like a distance sensor, the overall cost of the camera module becomes unfavorably high. On the other hand, in a case where the contrast-level-based focus technique is applied to a camera module in which the lens is shiftable in a stepwise manner between the normal photography position P1 and the macro photography position P2, a phenomenon in which an unfocused image and a focused image are switched in a stepwise manner always occurs during a focus operation. This phenomenon unfavorably imparts a sense of discomfort to the user.

### SUMMARY OF THE INVENTION

The present invention provides a camera system whose cost is lower than that of a camera system equipped with a distance sensor and which can prevent the phenomenon where an unfocused image and a focused image are switched in a stepwise manner during a focus operation in which a focal position is determined on the basis of contrast levels, so that a lens can be shifted automatically to the focal position without imparting a sense of discomfort to a user. The present invention also provides a method for controlling display during the focus operation.

A camera system according to the present invention includes a lens; an image pickup element picking up an image of a subject formed through the lens; a memory storing the image output from the image pickup element; a monitor displaying the image stored in the memory; lens shifting means for shifting the lens from a first photography position to a second photography position or from the second photography position to the first photography position; focusing means that allows the lens shifting means to shift the lens from the first photography position to the second photography position or from the second photography position to the first photography position when a focus operation is started, the focusing means determining a focal position by comparing a focus condition of an image obtained at the first photography position with a focus condition of an image obtained at the second photography position, the focusing means shifting the lens to the first photography position or the second photography position that is determined to be the focal position; and display controlling means for displaying an image obtained just prior to the start of the focus operation on the monitor in a period from the start to completion of the focus operation.

A method for controlling display during a focus operation according to the present invention includes a step for picking up an image of a subject formed through a lens; a step for storing the picked-up image into a memory; a step for displaying the image stored in the memory on a monitor; a step for shifting the lens from a first photography position to a second photography position or from the second photography position to the first photography position when the focus operation is started, determining a focal position by comparing a focus condition of an image obtained at the first photography position with a focus condition of an image obtained at the second photography position, and shifting the lens to the first photography position or the second photography position that is determined to be the focal position; and a step for displaying an image obtained just prior to the start of the focus operation on the monitor in a period from the start to completion of the focus operation.

According to the present invention, an image obtained just prior to the start of the focus operation is displayed on the monitor in a period from the start to completion of the focus operation so as to prevent the occurrence of a phenomenon in which an unfocused image and a focused image are switched in a stepwise manner. Thus, the lens can be shifted automatically to a focal position without imparting a sense of discomfort to the user.

In the camera system, the focusing means preferably determines the focus conditions from contrast levels of the images. Furthermore, the lens shifting means preferably includes a magnet provided on an outer periphery of a lens barrel holding the lens, and an electromagnetic coil disposed facing the magnet and separately therefrom. In this case, the lens is shifted and secured to the first photography position or the second photography position by applying electricity to the electromagnetic coil.

The camera system may further include detecting means for detecting a shutter operation which is a trigger for starting the focus operation, and image storing means for storing a focused image obtained after the completion of the focus operation, the focused image being stored in response to the shutter operation.

According to the present invention, a phenomenon where an unfocused image and a focused image are switched in a stepwise manner can be prevented during a focus operation in which a focal position is determined on the basis of contrast levels. Thus, a lens can be shifted automatically to the focal position without imparting a sense of discomfort to a user. In addition, cost reduction is achieved as compared with a case where a distance sensor is used.

### BRIEF DESCRIPTION OF THE DRAWINGS

FIG. 1 is a block diagram showing a general configuration of a camera system according to an embodiment of the present invention;

FIG. 2 is a sequence diagram illustrating an operation of the camera system shown in FIG. 1;

FIGS. 3A and 3B illustrate a focus technique that employs a contrast level of a photographed image;

FIG. 4 illustrates a structure of an example of a camera module in which switching between a normal photography position and a macro photography position is performed electrically; and

FIGS. 5A and 5B illustrate the switching operation of the lens position in the camera module shown in FIG. 4.

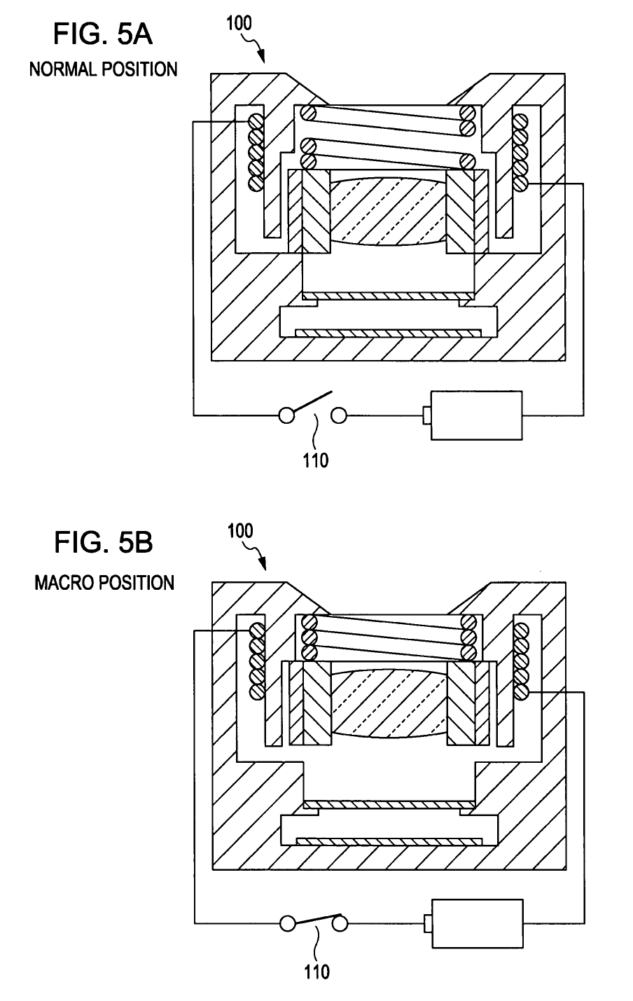

### DESCRIPTION OF THE PREFERRED EMBODIMENTS

Embodiments of the present invention will now be described with reference to the drawings.

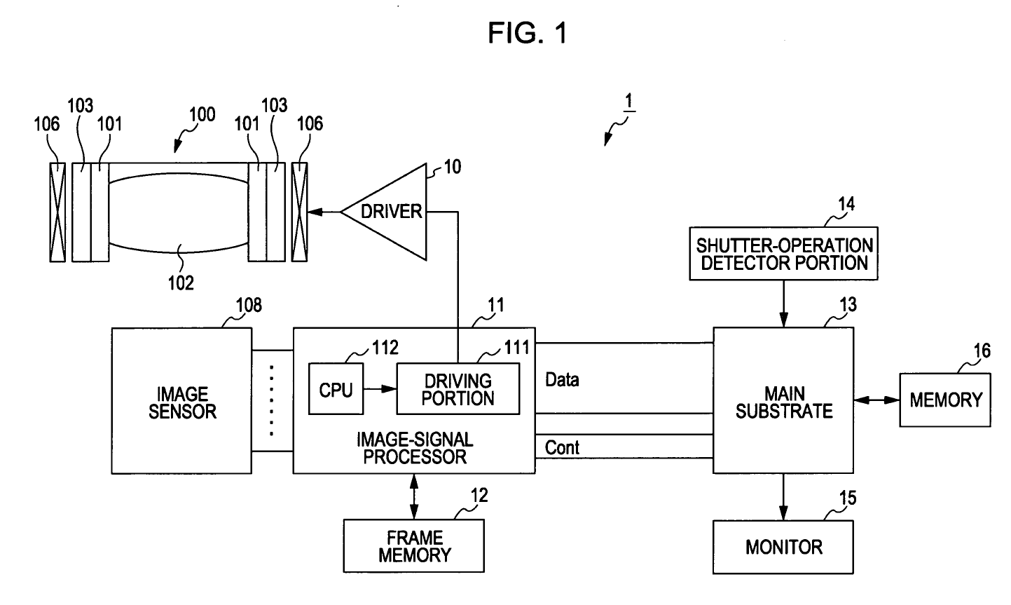

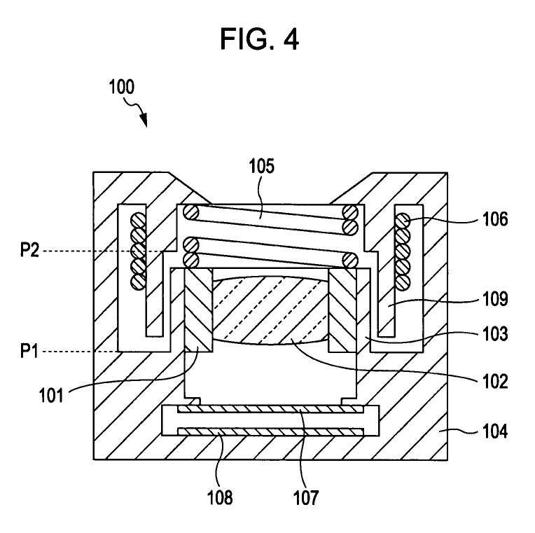

FIG. 1 is a block diagram showing a general configuration of a camera system 1 according to an embodiment of the present invention. Referring to FIG. 1, the camera system 1 is equipped with a camera module that is similar to the camera module 100 shown in FIG. 4, and is also equipped with a frame memory 12 having a storage capacity for storing at least two frames of image data. Components included in the camera module according to this embodiment are given the same reference numerals as those given to the components in the camera module 100 shown in FIG. 4.

The frame memory 12 is a first-in first-out (FIFO) memory and can store at least two frames of image data. In detail, the frame memory 12 repeats a process in which every time one frame of image is input to the frame memory 12, the frame memory 12 outputs the preceding image. The switching of the position of the lens 102 (i.e. the switching of the position of the lens barrel 101) is implemented by applying electricity to the electromagnetic coil 106 (see FIG. 4). The electric power for driving the electromagnetic coil 106 is supplied from a driver 10. When the driver 10 receives a drive signal from an image signal processor (ISP) 11, the driver 10 amplifies the drive signal and sends the amplified drive signal to the electromagnetic coil 106. The ISP 11 includes a driving portion 111 and a CPU 112. Specifically, the driving portion 111 sends the drive signal to the driver 10, while the CPU 112 controls the driving portion 111 in accordance with a program stored in a memory (not shown) built in the ISP 11. In addition, the CPU 112 also controls the supply of power to the electromagnetic coil 106 and performs various control operations for image processing in the ISP 11. The CPU 112 functions as focusing means for controlling a focus operation and also as display controlling means for controlling an image displayed on a monitor during the focus operation.

The CPU 112 stores images output from the image sensor 108 into the frame memory 12 on a frame-by-frame basis, and transfers the image data output from the frame memory 12 to a main substrate 13. Furthermore, when the CPU 112 receives a detection signal from the main substrate 13 indicating that a shutter button has been pressed halfway, the CPU 112 starts a focus operation and controls the switching of the lens 102 position. The shutter operation is performed by the user and is detected by a shutter-operation detector portion 14. The shutter-operation detector portion 14 is capable of detecting half-pressing of the shutter button, full-pressing of the shutter button, and releasing of the shutter button after the full-pressing (i.e. releasing of the user's finger from the shutter button). The shutter-operation detector portion 14 then sends the detection result to the main substrate 13. The CPU 112 starts the focus operation at the point of half-pressing of the shutter button.

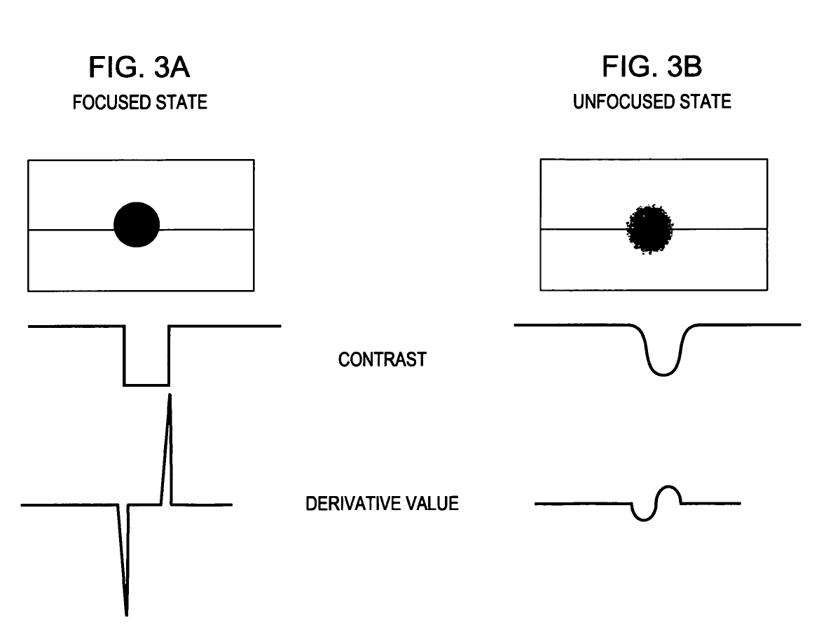

FIGS. 3A and 3B illustrate image contrast levels and derivative values in a focused state and an unfocused state, respectively. In the focused state as shown in FIG. 3A, the waveform that shows a contrast level is a rectangular wave with a sharp outline, and the derivative value thereof has an acute triangular waveform. On the contrary, in the unfocused state as shown in FIG. 3B, the waveform that shows a contrast level is similar to a sine wave with a blurry outline, and the derivative value thereof has a round waveform. Consequently, a focused state and an unfocused state can be distinguished from each other by comparing the derivative values of the contrast levels at different lens positions. However, the technique for analyzing a contrast level of an image is not specifically limited to this technique of calculating a derivative value.

As the CPU 112 shown in FIG. 1 starts a focus operation at the point of half-pressing of the shutter button, the CPU 112 reads out an image stored in the frame memory 12 just prior to the switching of focal position of the lens 102 and displays the image as a still image on a monitor 15 connected to the main substrate 13. In this manner, an image stored just prior to the start of a focus operation is displayed on the monitor 15 during the focus operation so that a blurry unfocused image and a sharp focused image are prevented from being displayed in a stepwise switching manner during the focus operation. This can reduce a sense of discomfort imparted to the user, which can be caused when a blurry image and a sharp image are displayed in a stepwise switching manner.

The ISP 11 is connected to the main substrate 13 through a data bus DB and a control bus CB, and exchanges data and control signals with the main substrate 13. The data bus DB transmits images processed in the ISP 11. The control bus CB transmits control signals, such as a clock signal, a data effective signal (horizontal synchronizing signal), a frame synchronizing signal (vertical synchronizing signal), and a strobe signal (shutter control, strobe control, etc.). The main substrate 13 has a detachable memory 16 connected thereto, which stores an image when the shutter button is fully pressed. The memory 16 functions as image storing means for storing a focused image after a focus operation when the shutter button is operated.

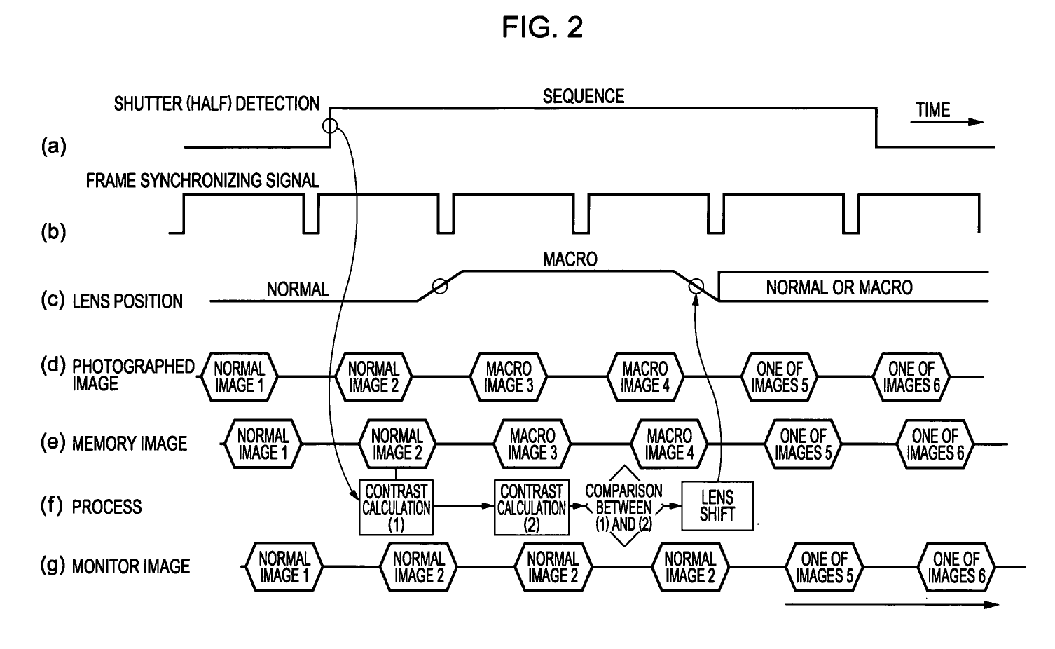

An operation of the camera system 1 according to this embodiment will be described below with reference to a sequence diagram shown in FIG. 2. In FIG. 2, part (a) shows a shutter detection signal, part (b) shows a waveform of a frame synchronizing signal, part (c) shows the focal position of the lens 102, part (d) corresponds to photographed images, part (e) corresponds to memory images stored in the frame memory 12, part (f) corresponds to a focusing process, and part (g) corresponds to images displayed on the monitor 15.

When the camera system 1 is activated and starts its operation, images are output from the image sensor 108 at a predetermined rate (e.g. 15 images per second) on the basis of a frame synchronizing signal. An image output from the image sensor 108 is temporarily stored in the frame memory 12 and is subsequently transferred to the main substrate 13 so as to be displayed on the monitor 15. In FIG. 2, the lens 102 is at the normal photography position before pressing of the shutter button, and therefore, a normal image is displayed on the monitor 15. In this embodiment, the normal photography position corresponds to a first photography position, whereas the macro photography position corresponds to a second photography position.

In this state, when the user presses the shutter button halfway, the shutter-operation detector portion 14 detects the half-pressed state of the shutter button and notifies the CPU 112 in the ISP 11 of the half-pressed state through the main substrate 13. When the CPU 112 in the ISP 11 receives the notification of the half-pressed state of the shutter button, the CPU 112 starts a focus operation and sends electricity to the electromagnetic coil 106 so that the focal position of the lens 102 is switched from the normal photography position, prior to the notification, to the macro photography position. Furthermore, of the images stored in the frame memory 12, an image (normal image 2) obtained just prior to the shifting of the lens 102 position is read out. This image (normal image 2) is continuously displayed on the monitor 15 until completion of the focus operation. Although the normal image 2 is displayed on the monitor 15 as a still image, since the duration of time to the completion of the focus operation is extremely short, a sense of discomfort imparted to the user is significantly reduced as compared with a case where a focused image and an unfocused image are displayed in a stepwise switching manner.

The CPU 112 calculates the contrast level of the normal image 2 obtained prior to the start of the shifting of the lens 102, and also calculates the contrast level of an image (macro image 3) at the macro photography position after the focal position of the lens 102 has been switched from the normal photography position to the macro photography position. The CPU 112 then compares the contrast level of the normal image 2 at the normal photography position prior to the shifting of the lens 102 with the contrast level of the macro image 3 at the macro photography position after the shifting of the lens 102, and determines the lens 102 position with the higher contrast level (the normal photography position or the macro photography position) as a focal position. In the sequence diagram shown in FIG. 2, if the normal photography position is determined as a focal position, the focal position of the lens 102 is shifted to the normal photography position. On the other hand, if the macro photography position is determined as a focal position, a lens shift operation is not implemented since the focal position of the lens 102 is already set at the macro photography position. When focused at either the macro photography position or the normal photography position, the image (normal image 2) at the point of half-pressing of the shutter button is no longer output, but a focused image (one of images 5) is output. Subsequently, when the shutter button is fully pressed, the image is taken into the main substrate 13 and is stored into the memory 16. When releasing of the shutter button is detected, the CPU 112 sets the focal position of the lens 102 to the normal photography position. In this case, if the focal position of the lens 102 is set at the normal photography position as a result of the focus operation, the lens 102 remains at that position, whereas if the focal position of the lens 102 is set at the macro photography position as a result of the focus operation, the lens 102 is shifted to the normal photography position.

Accordingly, the camera system 1 of this embodiment is equipped with the frame memory 12 having a capacity for storing at least two frames of image data, and stores images output from the image sensor 108 into this frame memory 12 on a frame-by-frame basis. Furthermore, the camera system 1 reads out the stored image data and displays the image data on the monitor 15. When the shutter button is pressed halfway, an image obtained prior to the start of the shifting of the lens 102 at the point of half-pressing of the shutter button is displayed on the monitor 15 until the focus operation is completed. On the other hand, the focus operation is performed in which the focal position of the lens 102 is shifted in a stepwise manner between the normal photography position and the macro photography position. When the focus operation is completed, the image is switched to a normal image or a macro image in a focused state. Accordingly, this prevents a focused image and an unfocused image from being displayed in a stepwise switching manner during a focus operation, thereby reducing a sense of discomfort imparted to the user.

Because the switching of the focal position of the lens 102 is performed by means of the magnetic segment (magnet) 103 and the electromagnetic coil 106, the lens 102 can be shifted quickly to each focal position. Consequently, even if an image stored just prior to the start of a focus operation is displayed in the course of the focus operation, the time period for displaying that image can be shortened, thereby reducing a sense of discomfort imparted to the user. Furthermore, the operationability is enhanced as compared to a case where the switching of focal position of the lens 102 is performed manually.

Furthermore, employing a contrast detection technique for focus determination can achieve cost reduction as compared to a case where a distance sensor is used.

Although the normal photography position is set as the usual focal position of the lens 102 in this embodiment, the usual focal position may alternatively be the macro photography position.

Furthermore, although the focal position of the lens 102 in this embodiment has two stages, i.e. the normal photography position and the macro photography position, the focal position of the lens 102 may alternatively have two or more stages.

The present invention is applicable to various types of electronic photographic devices that are equipped with an image sensor and an image signal processor, the various types including a digital camera, a portable telephone, and a web camera.

What is claimed is:

1. A camera system comprising:
a lens;
an image pickup element picking up an image of a subject formed through the lens;
a memory storing the image output from the image pickup element;
a monitor displaying the image stored in the memory;
lens shifting means for shifting the lens from a first photography position to a second photography position or from the second photography position to the first photography position;
focusing means that allows the lens shifting means to shift the lens from the first photography position to the second photography position or from the second photography position to the first photography position when a focus operation is started, the focusing means determining a focal position by comparing a focus condition of an image obtained at the first photography position with a focus condition of an image obtained at the second photography position, the focusing means shifting the lens to the first photography position or the second photography position that is determined to be the focal position; and
display controlling means for displaying an image obtained just prior to the start of the focus operation on the monitor in a period from the start to completion of the focus operation.

2. The camera system according to claim 1, wherein the focusing means determines the focus conditions from contrast levels of the images.

3. The camera system according to claim 1, wherein the lens shifting means includes a magnet provided on an outer periphery of a lens barrel holding the lens, and an electromagnetic coil disposed facing the magnet and separately therefrom, wherein the lens is shifted and secured to the first photography position or the second photography position by applying electricity to the electromagnetic coil.

4. The camera system according to claim 1, further comprising:
detecting means for detecting a shutter operation which is a trigger for starting the focus operation; and
image storing means for storing a focused image obtained after the completion of the focus operation, the focused image being stored in response to the shutter operation.

5. A method for controlling display during a focus operation, comprising:
a step for picking up an image of a subject formed through a lens;
a step for storing the picked-up image into a memory;
a step for displaying the image stored in the memory on a monitor;
a step for shifting the lens from a first photography position to a second photography position or from the second photography position to the first photography position when the focus operation is started, determining a focal position by comparing a focus condition of an image obtained at the first photography position with a focus condition of an image obtained at the second photography position, and shifting the lens to the first photography position or the second photography position that is determined to be the focal position; and
a step for displaying an image obtained just prior to the start of the focus operation on the monitor in a period from the start to completion of the focus operation.
